(19) United States
(12) Patent Application Publication
(10) Pub. No.: US 2012/0098282 A1
(43) Pub. Date: Apr. 26, 2012

(54) MULTI-PURPOSE TOOL

(75) Inventor: Timothy Langan, Mission Viejo, CA (US)

(73) Assignee: SHRIKE INDUSTRIES, INC., Laguna Hils, CA (US)

(21) Appl. No.: 13/279,159

(22) Filed: Oct. 21, 2011

Related U.S. Application Data
(63) Continuation-in-part of application No. 12/427,701, filed on Apr. 21, 2009.

(51) Int. Cl. B25F 1/02; A01D 9/00

(52) U.S. Cl. 294/49; 7/167

(57) ABSTRACT

A multi-purpose bar for use with interchangeable tool attachments is described. The bar includes a high strength-to-weight ratio design, providing a tool ideal for military, first-responder emergency scenarios, mountaineering, aerospace, and the like. The bar includes a hole for attaching a carabiner and universal connectors, such as snap joint fasteners, for quick interchangeability of tool attachments. A kit including the multi-purpose bar and at least two tool attachments is also described. The two tool attachments are preferably configured to removeably couple to one another, thus providing a third tool.

This application claims the benefit of priority to, and is a continuation-in-part of, U.S. patent application Ser. No. 12/427,701, filed on Apr. 21, 2009.

### FIELD OF THE INVENTION

The field of the invention is multi-purpose tools. Specifically, the present inventive subject matter relates to high strength low weight handles for interchangeable tool attachments.

### BACKGROUND

For millennia, people have used tools to perform manual or mechanical tasks. Tools can make many of the most laborious of tasks effortless and simple. Without an axe or other similar tool, slicing a log would prove to be very difficult. Therefore, it is of no surprise that most people will opt to use a tool when faced with a mechanical activity.

Shovels, hammers, and picks, to name a few different tools, all provide a valuable utility. Each tool, however, may provide a unique utility that other tools cannot. While a shovel is designed to allow a user to dig more easily, the shovel would provide little help in boring a hole through wood. Thus, the more tools one has available to them, the higher the utility one may have at his or her disposal.

While each tool may provide a unique utility, each tool may have its own unique dimensions and weight. Should one be faced with limited storage space or carrying capacity, such as military personnel, a rock climber, or a person on a camping trip, then they would be limited as to the type and number of tools they may bring along. In such a situation, the utility one would have at his or her disposal would be dependent upon their storage space or carrying capacity.

In a situation where one is faced with a limited storage space or carrying capacity, it would be advantageous for a tool to provide increased utility at a lower volume and weight cost. Thus, there is a need for a multi-purpose tool. Specifically, there is a need for a device that may provide the utility of a plurality of tools through the interchangeability of distinct tool attachments. It is to these ends that the present invention has been developed.

The Crovel™ sold at survivaloutdoorgear.com is one example of a multi-purpose tool current available. The Crovel™ has very limited uses and fails to provide a multi-purpose tool with sufficient strength and versatility.

This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for multi-purpose tool handles having low weight and high strength.

### SUMMARY OF THE INVENTION

The inventive subject matter provides apparatus, systems and methods in which a multi-purpose bar comprises an elongated member, first and second ends, and a through-hole. The first and second ends preferably have first and second universal connectors, such as snap joint fasteners.

In some aspects of preferred embodiments, at least 50% of the elongated member has a cross sectional shape of a cross. The bar preferably includes a plurality of recessed portions along sides of the cross. More preferably, the bar has no more than two recessed portions along the sides of the cross at any given length of the elongated member.

In other aspects of some preferred embodiments, the multi-purpose bar has an over mold covering the plurality of recessed portions. The over mold comprises at least two distinct materials in order to provide specific tactile characteristics. In yet other aspects of some preferred embodiments, the bar preferably has a weight no greater than 2.5 lbs and a flexural strength (3 point bending) of at least 42 psi.

The inventive subject matter also provides apparatus, systems and methods, in which a kit includes a multi-purpose bar as described above, and at least first and second tool attachments configured to removeably couple with the bar. The first and second attachments are preferably configured to removeably couple to one another, thus providing a third tool.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) illustrates a perspective view of a multi-purpose tool comprising a spike and a hammer and pick combination.

FIG. 1(b) illustrates a perspective view of another multi-purpose tool comprising a shovel and an axe.

FIG. 2 illustrates a side view of a multi-purpose tool comprising a hammer and pick combination, a spike and a knife.

FIG. 3 illustrates a side view of a multi-purpose tool comprising four distinct tools.

FIG. 4 illustrates a perspective view of a multi-purpose tool comprising four distinct tools.

FIG. 5 illustrates a perspective view of another embodiment of a multi-purpose tool bar having a core and an over mold.

FIG. 6 illustrates a perspective view of the core of the multi-purpose tool bar of FIG. 5.

FIG. 7 illustrates a close-up side view of the core of FIG. 6.

FIG. 8 illustrates three different cross section designs for the core of FIG. 6.

FIG. 9 illustrates the over mold of the multi-purpose bar of FIG. 5.

FIG. 10 illustrates a close-up perspective view of the hole of the multi-purpose tool bar of FIG. 5.

FIG. 11 illustrates a multi-purpose tool kit.

### DETAILED DESCRIPTION

One should appreciate that the disclosed techniques provide many advantageous technical effects including providing a multi-purpose bar with interchangeable tool attachments. Specifically, the bar's design achieves an excellent strength-to-weight ratio, allowing the bar to be used in numerous applications and in extreme conditions.

The following discussion provides many example embodiments of the inventive subject matter. Reference is made to the accompanying drawings, which include depictions of specific embodiments illustrating specific embodiments in which the invention may be practiced. It is to be understood that other embodiments may be utilized and changes may be made without departing from the scope of the present invention. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

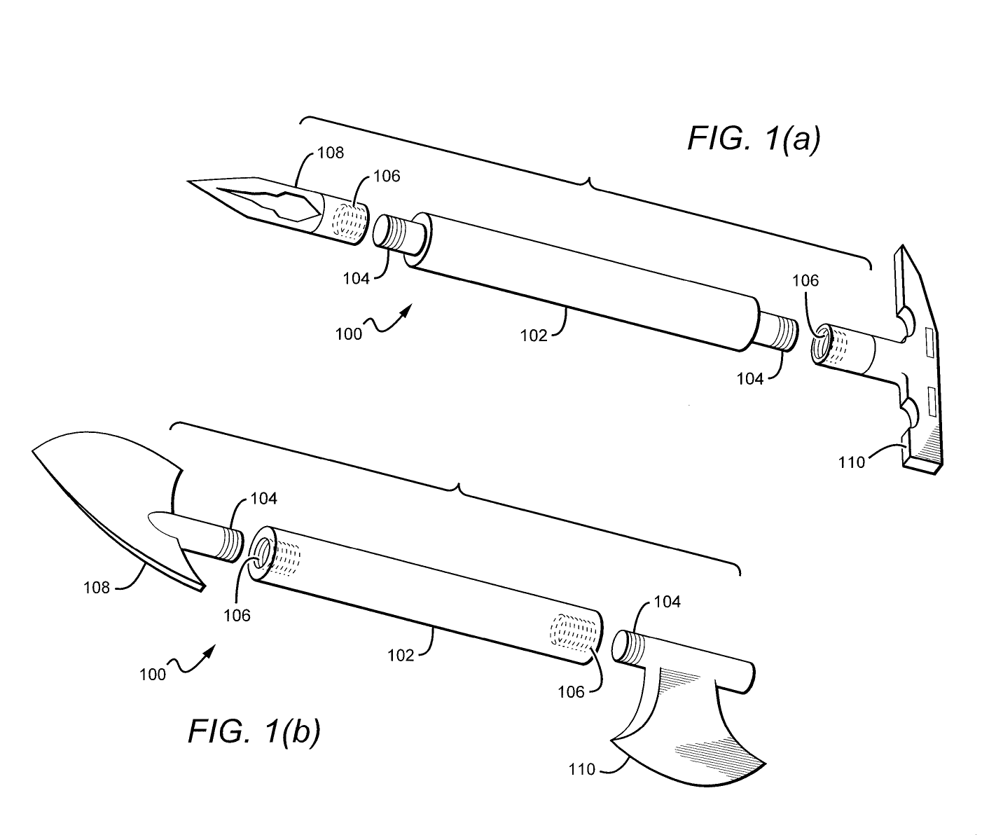

FIG. 1(a) illustrates a perspective view of a multi-purpose tool comprising a spike and a hammer and pick combination tool. FIG. 1(b) illustrates a perspective view of another multi-purpose tool comprising a shovel and an axe.

FIGS. 1(a) and 1(b) show multi-purpose tool 100, which comprises elongated member 102, universal connector 104, universal receiver 106, first distinct tool 108, and second distinct tool 110. Multi-purpose tool 100 is designed to provide the utility of a plurality of tools, but to also be comprised of a reduced weight and volume through the interchangeability of distinct tool attachments.

Elongated member 102 is the main body of multi-purpose tool 100. Elongated member 102 may be composed of a variety of materials, including wood, metals, alloys, plastics, or any other material that is sufficiently rigid so as to withstand normal wear and tear during use of multi-purpose tool 100. Additionally, elongated member 102 may be lightweight so as to reduce burden during use, storage or transport.

Elongated member 102 may be cylindrical or rectangular in shape, such that a user may securely, but comfortably, grip elongated member 102 in use or transport of multi-purpose tool 100. Additionally, the exterior surface of elongated member 102 may comprise a texture that would facilitate better grip of multi-purpose tool 100 by a user. In an exemplary embodiment, elongated member 102 may be a cylindrical rod, with a length between two and three feet. However, the shape or dimensions of elongated member 102 should not be interpreted so as to limit the scope of the present invention.

Universal connector 104 and universal receiver 106 are components of multi-purpose tool 00 designed to connect elongated member 102 to a plurality of distinct tools. Universal connector 104 and universal receiver 106 are designed to securely couple, attaching elongated member 102 to a distinct tool. However, universal connector 104 and universal receiver 106, when connected, may be disengaged so as to disconnect elongated member 102 from a distinct tool.

In the present embodiment, universal connector 104 may comprise a male-type component with threading. Universal receiver 106 may comprise a female-type component with corresponding threading to universal connector 104. In such an embodiment, universal connector 104 may securely couple with universal receiver 106 via a screw mechanism, wherein universal connector 104 may screw into universal receiver 106 via their corresponding threading.

In another embodiment of the present invention, universal connector 104 and universal receiver 106 may couple via a clamping mechanism. In such an embodiment, universal connector 104 may be received by universal receiver 106, which may securely couple to universal connector 104 via a clamp. In other embodiments of the present invention, however, universal connector 104 and universal receiver 106 may couple via other mechanisms, such as magnetism, a collet, snapping joints, or other different mechanical means of connection.

In the embodiment of the present invention depicted in FIG. 1(a), universal connectors 104 are situated at distal and proximal ends of elongated member 102, and universal receivers 106 are situated at the ends of a first distinct tool 108 and a second distinct tool 110, respectively. However, in another embodiment of the present invention as depicted in FIG. 1(b), universal receivers 106 may be situated at distal and proximal ends of elongated member 102, and universal connectors 104 may be situated at the ends of a first distinct tool 108 and a second distinct tool 110, respectively. Thus, the placement or locations of universal connectors 104 and universal receivers 106, with respect to multi-purpose tool 100, should not be interpreted so as to limit to scope of the present invention.

First distinct tool 108 is a tool accessory for multi-purpose tool 100 that may be securely attached to and removed from elongated member 102 via universal connector 104 and universal receiver 106. In the embodiment of the present invention as depicted in FIG. 1(a), first distinct tool 108 comprises a spike tool. However, first distinct tool 108 may comprise a shovel, as depicted in FIG. 1(b). Additionally, in other embodiments of the present invention, first distinct tool 108 may comprise another tool such as a hammer, pick, nail remover, axe, crowbar, helmet counterweight or other device or combination thereof.

Helmet counterweight is a device that may be used by law enforcement or military personnel to counterbalance the weight of a night vision goggle unit upon the front of a user's helmet. In one embodiment, a helmet counterweight may be attached to or removed from a helmet via hook and loop connectors or other method. In a preferred embodiment, the helmet counterweight may be designed such that each edge of helmet counterweight may provide the user with a different function. For example, one edge may be sharp enough such that helmet counterweight may be engaged as an axe, while one edge may be curved such that helmet counterweight may be engaged as a pick. Various embodiments of helmet counterweight may comprise a shovel, an axe, an awl, pry, or a pick.

Second distinct tool 110 is a tool accessory for multi-purpose tool 100 that may be securely attached to and removed from elongated member 102 via universal connector 104 and universal receiver 106. In the embodiment of the present invention as depicted in FIG. 1(a), second distinct tool 110 comprises a hammer and pick combination tool. However, second distinct tool 110 may comprise an axe, as depicted in FIG. 1(b). Further, in other embodiments of the present invention, second distinct tool 110 may comprise a spike, nail remover, shovel, crowbar, helmet counterweight, or other like device or combination.

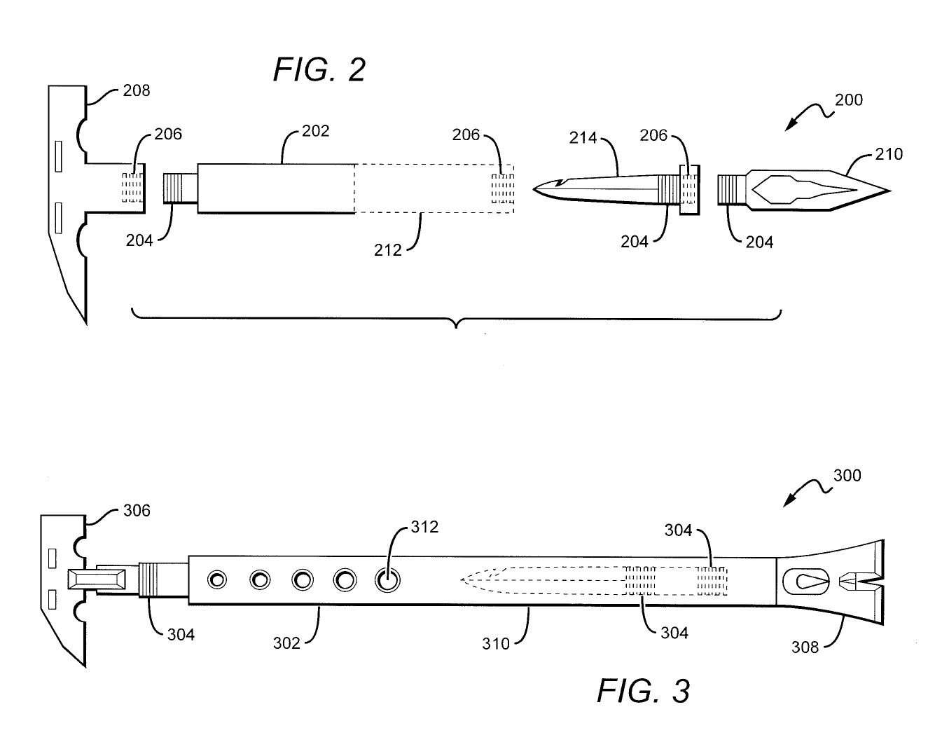

FIG. 2 illustrates a side view of a multi-purpose tool comprising a hammer and pick combination, a spike and a knife. FIG. 2 shows multi-purpose tool 200, which comprises elongated member 202, universal connector 204, universal receiver 206, first distinct tool 208, second distinct tool 210, interior region 212, and third distinct tool 214. Multi-purpose tool 200 is designed to provide the utility of a plurality of tools, but to also be comprised of a reduced weight and volume through the interchangeability of distinct tool attachments.

Elongated member 202 is the main body of multi-purpose tool 200. Elongated member 202 may be composed of a variety of materials, including wood, metals, alloys, plastics, or any other material that is sufficiently rigid so as to withstand normal wear and tear during use of multi-purpose tool 200. Elongated member 202 may be cylindrical or rectangular, such that a user may securely, but comfortably, grip elongated member 202 in use or transport of multi-purpose tool 200. Additionally, the exterior surface of elongated member 202 may comprise a texture that would facilitate better grip of multi-purpose tool 200 by a user. In a preferred embodiment, elongated member 202 may be a cylindrical rod, with a length between two and three feet.

Elongated member 202 may include interior region 212. Interior region 212 is a component of multi-purpose tool 200 designed to receive third distinct tool 214. In an exemplary embodiment of the present invention, the entire length of elongated member 202 may be hollow, comprising interior region 212. In such an embodiment, the length of interior region 212 may be equal to the length of elongated member 202. In other embodiments of the present invention, however, the length of interior region 212 may be less than that of elongated member 202. In such an embodiment, elongated member 202 may comprise both an interior region 212 and a solid, non-hollow region.

Universal connector 204 and universal receiver 206 are components of multi-purpose tool 200 designed to connect elongated member 202 to a plurality of distinct tools. Universal connector 204 and universal receiver 206 are designed to securely couple, attaching elongated member 202 to a distinct tool. Universal connector 204 and universal receiver 206 may also be disengaged so as to disconnect elongated member 202 from a distinct tool.

In the present embodiment, universal connector 204 may securely couple with universal receiver 206 via a screw mechanism, wherein universal connector 204 may screw into universal receiver 206 via their corresponding threading. In another embodiment of the present invention, however, universal connector 204 and universal receiver 206 may couple via other mechanisms, such as clamping, magnetism, a collet, snapping joints, or other different mechanical means of connection.

First distinct tool 208 is a tool accessory for multi-purpose tool 200 that may be securely attached to and removed from elongated member 202 via universal connector 204 and universal receiver 206. In the embodiment depicted in FIG. 2, first distinct tool 208 may comprise a hammer and pick combination. However, in other embodiments of the present invention, first distinct tool 208 may comprise another tool such as a spike, shovel, nail remover, axe, crowbar, helmet counterweight, knife or other device or combination thereof.

Second distinct tool 210 is a tool accessory for multi-purpose tool 200 that may be securely attached to and removed from elongated member 202 via universal connector 204 and universal receiver 206. In the embodiment depicted in FIG. 2, second distinct tool 210 comprises a spike tool. However, in other embodiments of the present invention, second distinct tool 210 may comprise a hammer, pick, axe, nail remover, shovel, crowbar, helmet counterweight, knife, or other like device or combination.

Interior region 212 may be designed to receive or contain third distinct tool 214. Third distinct tool 214 is a tool accessory for multi-purpose tool 200 that may be securely attached to and removed from elongated member 202 via universal connector 204 and universal receiver 206. When connected to elongated member 202, third distinct tool 214 may be situated within interior region 212. In such an embodiment, the length of third distinct tool 214 may be less than or equal to the length of interior region 212 and have a radius less than or equal to the radius of interior region 212. Universal connector 204 and universal receiver 206 may be disengaged in order to remove third distinct tool 214 from within interior region 212. In such exemplary usage, universal connector 204 and universal receiver 206 may be disengaged to separate second distinct tool 210 from third distinct tool 214.

In the embodiment of the present invention depicted FIG. 2, third distinct tool 214 comprises a knife. However, in other embodiments of the present invention, third distinct tool 214 may comprise a screwdriver, scissors, pick, nail remover, shovel, or other like device or combination.

FIG. 3 illustrates a side view of a multi-purpose tool comprising four distinct tools. FIG. 3 shows multi-purpose tool 300, which comprises elongated member 302, universal connection 304, first distinct tool 306, second distinct tool 308, third distinct tool 310, and fourth distinct tool 312. Multi-purpose tool 300 is designed to provide the utility of a plurality of tools, but to also be comprised of a reduced weight and volume through the interchangeability of distinct tool attachments.

Elongated member 302 is the main body of multi-purpose tool 300. Elongated member 302 may be composed of a variety of materials, including wood, metals, alloys, plastics, or any other material that is sufficiently rigid so as to withstand normal wear and tear during use of multi-purpose tool 300. Elongated member 302 may be cylindrical or rectangular, such that a user may securely, but comfortably, grip elongated member 302 in use or transport of multi-purpose tool 300. In a preferred embodiment, elongated member 302 may be a cylindrical rod, with a length between two and three feet. However, the shape or dimensions of elongated member 302 should not be interpreted so as to limit the scope of the present invention.

Elongated member 302 may include an interior region for enclosing third distinct tool 310. In an exemplary embodiment of the present invention, the length of the interior region inside elongated member 302 may be equal to the length of third distinct tool 310. In another embodiment of the present invention, however, the length of the interior region may be longer than the length of third distinct tool 310.

Universal connection 304 comprises a universal connector and a universal receiver. Universal connector and universal receiver may be disengaged in order to disconnect distinct tools from elongated member 302.

First distinct tool 306 is a tool accessory for multi-purpose tool 300 that may be securely attached to and removed from elongated member 302 via a universal connector and universal receiver. In the embodiment depicted in FIG. 3, first distinct tool 306 may comprise a hammer and pick combination. However, in other embodiments of the present invention, first distinct tool 306 may comprise another tool such as a spike, shovel, nail remover, axe, crowbar, helmet counterweight, knife or other device or combination thereof.

Second distinct tool 308 is a tool accessory for multi-purpose tool 300 that may be securely attached to and removed from elongated member 302 via a universal connector and universal receiver. In this embodiment, second distinct tool 308 comprises a crowbar tool. However, in other embodiments of the present invention, second distinct tool 308 may comprise another tool such as a spike, hammer, pick, shovel, nail remover, axe, helmet counterweight, knife or other device or combination thereof.

Third distinct tool 310 is a tool accessory for multi-purpose tool 300 that may be securely attached to and removed from elongated member 302 via a universal connector and universal receiver. When connected to elongated member 302, third distinct tool 310 may be situated inside an interior region within elongated member 302. In the present embodiment, third distinct tool 310 comprises a knife. However, in other embodiments of the present invention, third distinct tool 310 may comprise a screwdriver, hook, scissors, pick, nail remover, shovel, or other like device or combination.

Fourth distinct tool 312 is a tool accessory for multi-purpose tool 300 located within elongated member 302. In the present embodiment, fourth distinct tool 312 comprises a plurality of lateral spaced wire cutters along the length of elongated member 302. In the present embodiment, fourth distinct tool 312 may not be removed from elongated member 302. In other embodiments of the present invention, however, fourth distinct tool 312 may be removed from elongated member 302, or may comprise another device.

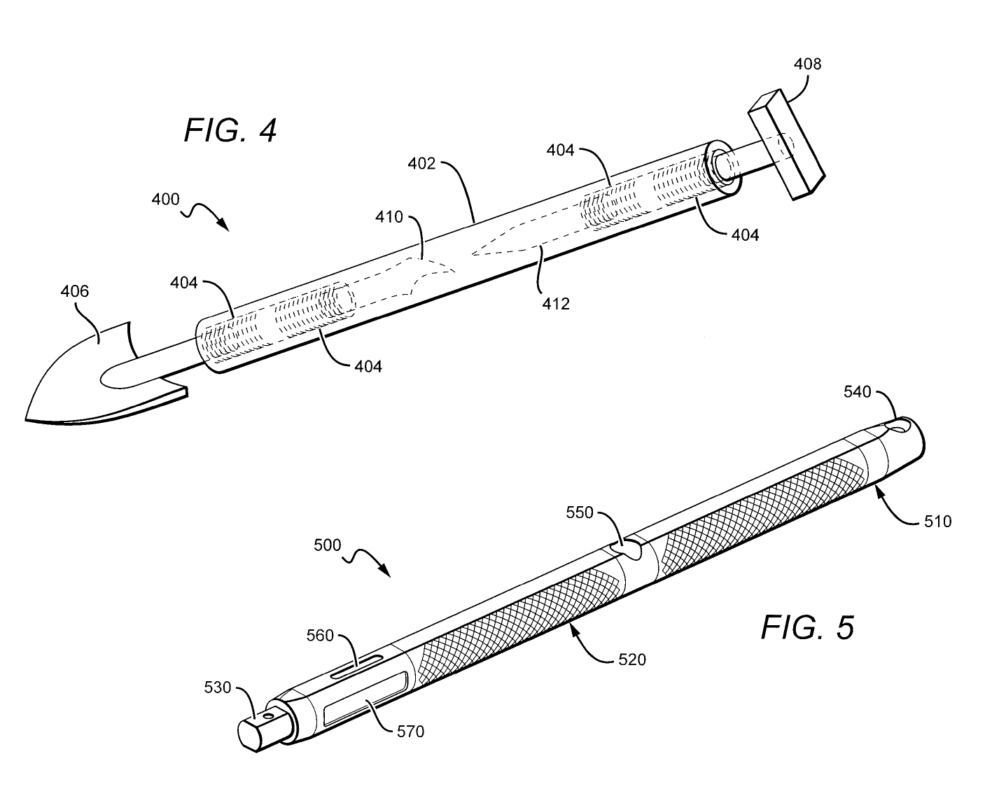

FIG. 4 illustrates a perspective view of a multi-purpose tool comprising four distinct tools. FIG. 4 shows multi-purpose tool 400, which comprises elongated member 402, universal connection 404, first distinct tool 406, second distinct tool 408, third distinct tool 410, and fourth distinct tool 412. Multi-purpose tool 400 is designed to provide the utility of a plurality of tools, but to also be comprised of a reduced weight and volume through the interchangeability of distinct tool attachments.

Elongated member 402 is the main body of multi-purpose tool 400. Elongated member 402 may be composed of a variety of materials, including wood, metals, alloys, plastics, or any other material that is sufficiently rigid so as to withstand normal wear and tear during use of multi-purpose tool 400. Elongated member 402 may be cylindrical or rectangular, such that a user may securely, but comfortably, grip elongated member 402 in use or transport of multi-purpose tool 400. In a preferred embodiment, elongated member 402 may be a cylindrical rod, with a length between two and three feet. However, the shape or dimensions of elongated member 402 should not be interpreted so as to limit the scope of the present invention.

Elongated member 402 may include a plurality of interior regions for the enclosure of distinct tools. In the present embodiment, elongated member 402 includes two interior regions for enclosing and removing third distinct tool 410 and fourth distinct tool 412. In other embodiments, however, multi-purpose tool 400 may include more than two interior regions for storage and removable of distinct tools. In an exemplary embodiment of the present invention, the total length of the interior regions inside elongated member 402 may be equal to the length of third distinct tool 410 and fourth distinct tool 412, respectively. In another embodiment of the present invention, the lengths of the interior regions within elongated member 402 may be longer than the lengths of third distinct tool 410 and fourth distinct tool 412, but shorter than the total length elongated member 402.

Universal connection 404 comprises a universal connector and a universal receiver. Universal connector and universal receiver may be engaged to securely attach a distinct tool to elongated member 402, and may be disengaged in remove a distinct tool from elongated member 402.

First distinct tool 406 is a tool accessory for multi-purpose tool 400 that may be securely attached to and removed from elongated member 402 via a universal connector and universal receiver. In the embodiment depicted in FIG. 4, first distinct tool 406 comprises a shovel. However, in other embodiments of the present invention, first distinct tool 406 may comprise another tool such as a spike, hammer, pick, nail remover, axe, crowbar, helmet counterweight, knife or other device or combination thereof.

Second distinct tool 408 is a tool accessory for multi-purpose tool 400 that may be securely attached to and removed from elongated member 402 via a universal connector and universal receiver. In this embodiment, second distinct tool 408 comprises a block tool. However, in other embodiments of the present invention, second distinct tool 408 may comprise another tool such as a spike, hammer, pick, shovel, nail remover, axe, crowbar, helmet counterweight, knife or other device or combination thereof.

Third distinct tool 410 is a tool accessory for multi-purpose tool 400 that may be securely attached to and removed from elongated member 402 via a universal connector and universal receiver. When connected to elongated member 402, third distinct tool 410 may be situated inside an interior region within elongated member 402. In the present embodiment, third distinct tool 410 comprises a hook. However, in other embodiments of the present invention, third distinct tool 410 may comprise a knife, screwdriver, scissors, pick, nail remover, shovel, or other like device or combination.

Fourth distinct tool 412 is a tool accessory for multi-purpose tool 400 that may be securely attached to and removed from elongated member 412 via a universal connector and universal receiver. When connected to elongated member 402, fourth distinct tool 412 may be situated inside an interior region within elongated member 402. In the present embodiment, fourth distinct tool 412 comprises a knife. However, in other embodiments of the present invention, fourth distinct tool 412 may comprise a hook, screwdriver, scissors, pick, nail remover, shovel, or other like device or combination.

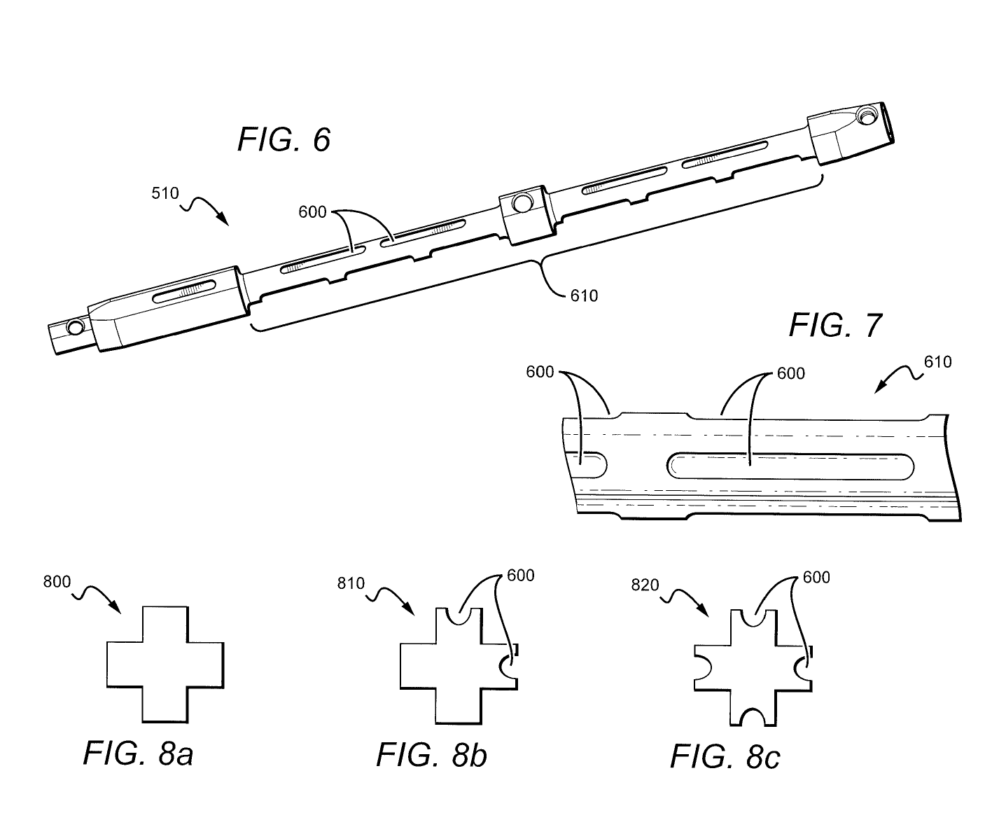

FIG. 5 shows a multi-purpose bar 500 having a core 510 and a soft grip portion 520. Bar 500 has a male snap joint 530 and a female snap joint 540. Multi-purpose bar 500 can be used as a handle for interchangeable toot attachments in a similar fashion to the elongated members discussed above. However, bar 500 includes several improvements over the elongated members previously discussed. First, bar 500 includes snap joints 530 and 540 rather than threaded universal connectors. This allows tools to be attached and removed more quickly. It also allows non-symmetrical tools to be attached in both a right-handed orientation and a left-handed orientation. Second, bar 500 includes a center hole 550, which can be used for various applications, as discussed below (see discussion on FIG. 10). Third, bar 500 includes a soft grip portion for absorbing impact and providing a non-slip surface. Fourth, bar 500 has a unique cross-section design for improving the bar's strength-to-weight ratio (see FIGS. 6-8). Finally, bar 500 includes additional utilities such as slot 560 (for receiving straps, fasteners) and blade sharpener 570 (or alternatively, magnesium fire starter 570).

The dimensions and configurations of the features of snap joints 530 and 540 have been especially designed and manufactured to withstand high-impact forces experienced by hand-held shovels, picks, sledgehammers, and similar tools. For example, male snap join 530 has a large diameter and length, and sufficiently thick protrusions to maintain engagement with a female snap joint, even under high impact use. It is further contemplated that bar 500 could include two female snap joints or two male snap joints rather than one of each. However, when a female and male snap joint are provided at opposite ends of the bar, several multi-purpose bars can be linearly connected together to form a long bar, handle, or lever.

FIG. 6 shows solid core 510 of bar 500 with soft grip portion 520 removed from section 610. Core 510 has a unique design for achieving a high strength-to-weight ratio. As used herein, the term “strength” refers to an ability to resist a force. Examples of strength indicators can include flexural strength (e.g., three point bending test), torsion rigidity, fracture toughness, impact absorption, fatigue resistance, tension load resistance, compression load resistance, and hardness. However, this list is non-limiting and other material properties may serve as indicators of strength.

Core 510 includes a plurality of staggered recessed portions 600 throughout a portion of the length of bar 500. Recessed portions 600 serve the purpose of providing a surface to which over mold 520 can grip, preventing slip between core 510 and over mold 520 when a torsion force is applied. Recessed portions 600 also help to increase strength-to-weight ratio. In addition, recessed portions 600 allows over mold 520 and core 510 to be integrated, thus improving impact absorption and fatigue resistance (e.g., reduction in crack propagation). Core 510 can be made of any material suitable for providing desired strength and weight requirements. Materials specifically contemplated are 17-4 Stainless steel, hi-grade aircraft aluminum, and carbon fiber. However, other materials may also be used consistently with the inventive subject matter disclosed herein, for example, titanium.

FIG. 7 shows a close-up of a portion of section 610. Recessed portions 600 are shown in a staggered configuration. The staggered configuration is best understood by FIGS. 8a-8c, which show various cross sectional designs 800, 810, and 820. Cross section 800 is shaped generally as a cross. The corners and edges of cross section 800 can preferably be rounded to reduce fracture points. Section 610 has a cross section design 800 at points along the length of section 610 where there are no recessed portions 600. Cross section 810 shows the cross section of section 610 at points where there are two recessed portions 600 on neighboring sides of bar 500. Cross section design 820 shows the cross section of a bar having recessed portions on all sides. Cross section 820 is less desirable than cross section 810, since it provides less strength than cross section 810. Section 610 preferably has no points at which there is a cross section design 820. This is accomplished by staggering recessed portions along the lengths and sides of bar 500. While cross section 600 shows recessed portions on two neighboring sides, it is contemplated that recessed portions 600 could be staggered and positioned such that the recessed portions 600 are on opposite sides. It is also contemplated that a cross section design could exist in which three of the four sides of bar 500 have recessed portions. However, no more than two recessed portions per cross section are preferred.

Bar 500 is preferably configured with a material, length, diameter, and number of recessed portions such that it preferably has a weight no greater than 2.5 lbs and a flexural strength (three point bending) of at least 42 psi.

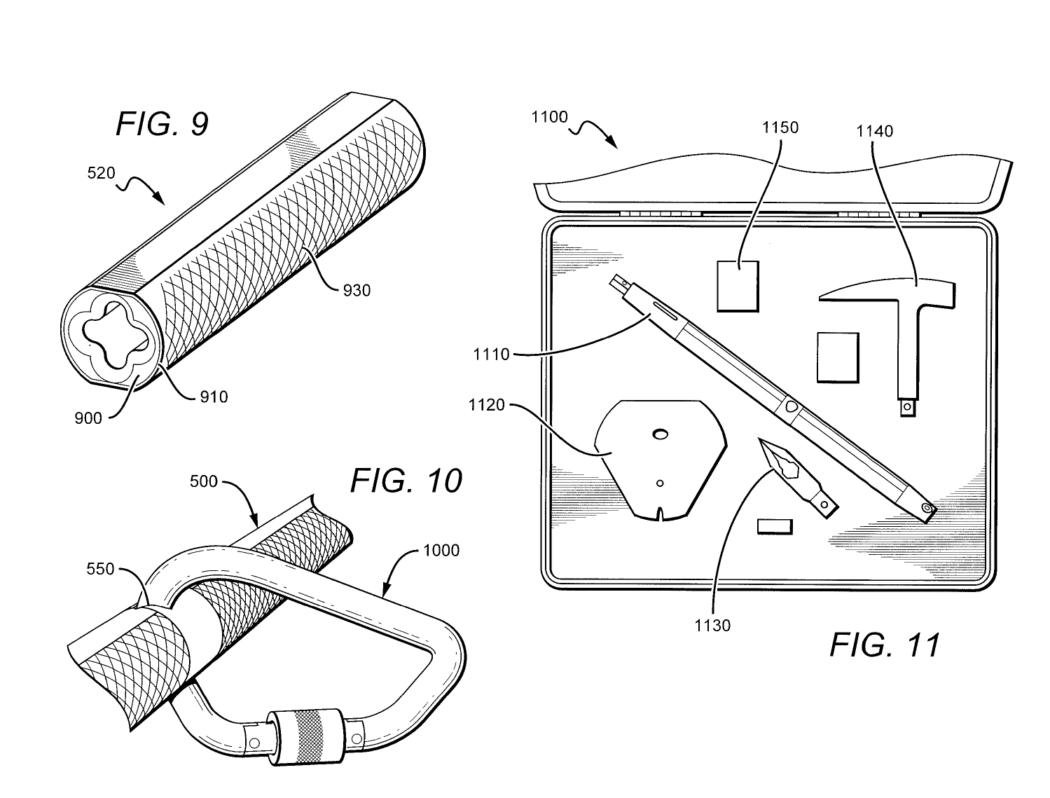

FIG. 9 shows over mold 520. Mold 520 preferably consists of at least two different materials: an inner layer 900 consisting of a harder plastic (e.g., polycarbonate) and an outer layer 910 consisting of a softer material (e.g., rubber). The material properties of the inner and outer layers (e.g., hardness, flexibility, stiffness) can be further optimized to improve shock absorption, fracture toughness, tactile grip/feel, flexural strength, etc, of bar 500. Mold 520 also has a surface pattern 930 for providing better grip and feel. Pattern 930 and/or outer layer 910 may also be configured to provide friction in the presence of water. It is also contemplated that the thermal expansion properties of mold 520 can be configured to match core 510 in order to prevent cracking of either core 510 or over mold 520 due to extreme cyclic temperature changes. In addition, a UV inhibitor or no-slip grip technology can be added to mold 520 and/or bar 500 to provide further functionality.

FIG. 10 shows one use for hole 550. Carabiner 1000 is placed through hole 550 to provide a secure point for repelling. For example, first and second users can secure each end of bar 500 while a third user hooks a harness to carabiner 1000 for repelling. Bar 500 advantageously provides a high strength-to-weight ratio, allowing the bar and tool attachments to be used in situations where weight is a concern (e.g., mountaineering, emergency rescue, military, aerospace). Hole 550 can be further configured with a female snap joint, thus allowing a second multi-purpose bar to be attached thereto in a T or cross configuration (e.g., cross bar, tire iron, leverage bar).

FIG. 11 shows a kit 1100 comprising: a multipurpose bar 1110, counterweight 1120, spearhead 1130, pick/hammer 1140, and sniper rest 1150. Counterweight 1120 can also be used as a platform/base or a shovel, as disclosed in pending U.S. application Ser. No. 12/333,267, which is incorporated herein by reference.

Kit 1110 may also include any other number of attachments, such as a ball plunger, glass extractor, or magnesium fire starter. It is also contemplated that the tool attachments of kit 1110 could connect together to form a third tool. For example, pick 1140 and spearhead 1130 could be connected together to form a grappling device.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A multi-purpose bar comprising:
an elongated member having first and second ends and a through-hole; and
wherein first and second ends have first and second universal connectors.

2. The bar of claim 1, wherein at least 50% of the elongated member has a cross sectional shape of a cross.

3. The bar of claim 2, further comprising a plurality of recessed portions along sides of the Cross.

4. The bar of claim 3, wherein there are no more than two recessed portions along the sides of the cross at any given length of the elongated member.

5. The bar of claim 4, further comprising an over mold covering the plurality of recessed portions.

6. The bar of claim 5, wherein the over mold comprises at least two distinct materials.

7. The bar of claim 1, wherein the bar has a weight no greater than 2.5 lbs and a flexural strength (3 point bending) of at least 42 psi.

8. A kit comprising:
the multi-purpose bar of claim 1; and
at least first and second tool attachments configured to removeably couple with the bar.

9. The kit of claim 8, wherein the first tool attachment comprises a helmet counterweight-shovel.

10. The kit of claim 8, wherein the first and second attachments are configured to removeably couple to one another.
